(19) United States
(12) Patent Application Publication
(10) Pub. No.: US 2007/0204879 A1
(43) Pub. Date: Sep. 6, 2007

(54) Dental flosser with advancement and tension adjustment mechanisms

(76) Inventors: Yun Chen, Germantown, MD (US); Wei Huang, Germantown, MD (US)

Correspondence Address: Donald W. Meeker, 924 East Ocean Front # E, Newport Beach, CA, 92661, US

(21) Appl. No.: 11/712,862

(22) Filed: Mar. 1, 2007

Related U.S. Application Data
(60) Provisional application No. 60/777,982, filed on Mar. 2, 2006.

(51) Int. Cl. A61C 15/00

(52) U.S. Cl. 132/325

(57) ABSTRACT

A handle houses a dental floss supply reel and a dental floss take-up reel in separate chambers. Movement and tension of a single long strand of dental floss through a pair of arched flossing arms is controlled by a new dental floss supply control knob, and a used dental floss take-up control knob. Spring loaded ratchets control the action of the reels. A hygienic cover protects the flossing arms. A small brush stored in the cover cleans the used dental floss of debris.

### CROSS-REFERENCE TO RELATED APPLICATIONS

This utility patent application claims the benefit of provisional application No. 60/777,982 filed Mar. 2, 2006.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

### Field of the Invention

The present invention relates to dental floss holders and particularly to a dental flossing device which comprises a handle housing a dental floss supply reel and a dental floss take-up reel, a dental floss supply control knob, a dental floss take-up control knob, a bifurcated angled flossing head, an extension arm connecting the flossing head to the handle, and a channel extending through the extension arm which allows floss to be run from the supply reel to the flossing head and back to the take-up reel; a hygienic cover is provided to protect and cover the extension arm and flossing head and is provided with an auxiliary aperture for holding a small cleaning brush. Description of Related Art including information disclosed under 37 CFR 1.97 and 1.98

After eating, food residual usually sticks between teeth, which causes dental diseases. The American Dental Association (ADA) recommends each individual to floss and/or brush teeth to get rid of the acidic foods stuck between teeth. It is estimated that floss and/or interdental brushes are used by over 50% of the population in the United States for personal oral hygiene. By 2003, Americans purchased over 4.3 million kilometers (2.67 million miles) of dental floss per year. Therefore, the market for novel and unique personal oral hygienic products faces huge potential.

Dental health is important, and has been shown to directly affect a person's overall physical health. Daily flossing is required to maintain good dental health and is proven to be highly effective in removing plaque and reducing gingivitis. Dental floss is generally wound about the index finger of each hand of the user. Following that, the stretched floss between the user's fingers is inserted into the spaces between the user's teeth.

Cutting dental floss can sometimes be difficult with strands of floss separating and disposing of used dental floss is often messy and unsightly. Prior art devices for flossing do not provide the best combination of self-contained floss adjustable to the desired tension with no floss cutting and floss disposal problems.

U.S. Patent Application #20060260637, published Nov. 23, 2006 by Kossak, claims a manually held dental flossing device that is characterized by a flossing circuit comprised of a flossing supply spool and a take-up spool mounted to a housing. The floss feeds from the supply spool along a pair of prongs forming a fork extension of the handle and is stretched across the prongs and appropriately tensioned to be inserted into a user's mouth for flossing. To maintain tension, a pair of ratchet pawls are jointly engageable with a ratchet mounted for co-rotation with the take-up spool. The pawls are offset relative to the ratchet teeth to ensure appropriate tension. Tension on the supply spool side of the flosser is achieved with a tension arm in constant engagement with tension teeth co-rotatably mounted with the spool. When a floss advancing trigger is not depressed, a brake pawl formed at one end of the trigger is spring biased into locking engagement with these teeth while the tension arm assures proper tension on the supply side. In an alternative preferred embodiment, only one tensioning ratchet pawl engages the ratchet mounted for co-rotation with the take-up spool. A different ratchet pawl, mounted to one end of a ratchet arm pivotally secured to the flosser housing beneath the ratchet, is engaged by the trigger to drivingly contact the ratchet to rotate the take-up spool. In this latter embodiment, the brake pawl is replaced with a projection formed on the trigger that is adapted to engage the supply spool tensioning ratchet to lock the ratchet in the released position of the trigger to prevent supply spool rotation and maintain the floss circuit in a tight condition.

U.S. Patent Application #20060011212, published Jan. 19, 2006 by Achepohl, describes a manual advance floss holder which is simple and inexpensive to construct, comfortable to grasp, convenient to use in one hand and presents floss for flossing under uniform and proper tension while protecting the supply of unused floss from contamination including a body with a fork located at its distal end, a floss control mechanism within the body of the manual advance floss holder, a floss control mechanism including supply and take-up reels and means for advancing the floss therebetween under tension, and different compartments within the body for isolating spent and fresh floss.

U.S. Patent Application #20050263169, published Dec. 1, 2005 by Romine, discloses a dental flossing tool and dispenser that includes a case with an enclosed chamber divided by a partition wall into floss spool and take up reel compartments. A hub mounts a floss spool for rotation within the floss spool compartment. A take up reel is rotatable within the take up reel compartment. A rotator on the take up reel, is at least partially disposed outward of the take up reel compartment. Floss in-feed and out-feed openings in the case communicate with the respective compartments. A length of floss extends through the floss out-feed opening and back into the take up reel compartment through the floss in-feed opening, thereby forming a bight in the floss outward of the case. A unidirectional rotation limiter allows rotation of the take up reel to take up the length of floss but inhibits pay out of floss.

U.S. Patent Application #20060254610, published Nov. 16, 2006 by Chen, puts forth a dental floss applicator which comprises a housing, a dental floss stick, a floss spool, a spring rack, a take-up wheel, and a rotary knob with a springy ratchet on the inside. The spring rack has a stop portion engaged with a gear wheel fastened to the floss spool to stretch the dental floss, and a press portion extending to the outside of the housing for pressing by the user to loosen the dental floss on the dental floss stick. The springy ratchet releases the stop portion of the spring rack step by step upon rotation of the rotary knob, allowing the used segment of the dental floss to be taken up. U.S. Pat. No. 7,082,950, issued Aug. 1, 2006 to Kossak, provides a manually held dental flossing device that is characterized by a flossing circuit comprised of a flossing supply spool and a take-up spool mounted to a housing. The floss feeds from the supply spool along a pair of prongs forming a fork extension of the handle and is stretched across the prongs and appropriately tensioned to be inserted into a user's mouth for flossing. To maintain tension, a pair of ratchet pawls are jointly engageable with a ratchet mounted for co-rotation with the take-up spool. The pawls are offset relative to the ratchet teeth to ensure appropriate tension. Tension on the supply spool side of the flosser is achieved with a tension arm in constant engagement with tension teeth co-rotatably mounted with the spool. When a floss advancing trigger is not depressed, a brake pawl formed at one end of the trigger is spring biased into locking engagement with these teeth while the tension arm assures proper tension on the supply side. In an alternative preferred embodiment, only one tensioning ratchet pawl engages the ratchet mounted for co-rotation with the take-up spool. A different ratchet pawl, mounted to one end of a ratchet arm pivotally secured to the flosser housing beneath the ratchet, is engaged by the trigger to drivingly contact the ratchet to rotate the take-up spool. In this latter embodiment, the brake pawl is replaced with a projection formed on the trigger that is adapted to engage the supply spool tensioning ratchet to lock the ratchet in the released position of the trigger to prevent supply spool rotation and maintain the floss circuit in a tight condition.

Two U.S. Patents, U.S. Pat. No. 5,678,578 issued Oct. 21, 1997 and U.S. Pat. No. 5,947,133 issued Sep. 7, 1999 to Kossak, show a dental flossing device having a flossing circuit comprising a floss supply spool and a take-up spool mounted to a housing containing a gear train assembly adapted to rotate the take-up spool in a winding direction. The floss feeds from the supply spool along a pair of prongs forming a forked extension of the handle and is stretched across the forked prongs and appropriately tensioned to be inserted into a user's mouth for flossing. To maintain hygiene, the take-up spool is mounted outside the housing. In a manually operated embodiment, a manually depressible trigger projecting from the housing is operable to rotate the take-up spool with reverse rotation thereof being prevented with a ratchet mechanism. Release of the manually depressible trigger reversely rotates the supply spool through a short arcuate interval to remove slack and then locks the supply spool against unwinding rotation through gear teeth. In a preferred manually operated embodiment, first and second ratchet mechanisms are utilized to prevent reverse rotation of the supply and take-up spools while sufficiently tensioning the floss circuit. In other embodiments, the housing may be formed for mounting the flossing device as an attachment to a hand-held motorized toothbrush handle equipped with a motor from which projects and output shaft. Depending upon the model, the gear train assembly may be modified to convert longitudinal stroking motion of the shaft or oscillatory motion into unidirectional rotating motion to rotate the take-up spool in one direction only.

U.S. Pat. No. 6,363,949, issued Apr. 2, 2002 to Brown, claims a dental care device combines a flossing tool for dispensing dental floss and holding a length of the floss under tension with a double-edged tongue scraper. The dental care device includes an ergonomic handle. A floss fork is connected to one end of the handle and includes a pair of prongs extending outwardly from the handle, the prongs each having tips adapted to support a length of dental floss across the gap between the prongs. The device includes a floss tensioner having a floss cog rotatably mounted in the handle. The handle includes a tool storage compartment which may be used to contain dental hygiene tools such as a microbrush and a pick.

U.S. Pat. No. 5,269,331, issued Dec. 14, 1993 to Tanriverdi, describes a self-contained dental flosser, with adjustable tension control and auto-tension locking mechanism, allows flosser to operate and advance the floss continuously in one direction by rotating the spool where the spool gears extend out of the main frame. Operation is as simple as rotating the spool by thumb and adjusting the tension by one finger, if necessary. The flosser contains a total of three parts: 1) an elongated body with a lid containing two stabilizing cylinders, a locking mechanism, two prongs set on an angle for effortless flossing, hollow axles in separate compartments, and a separation wall, 2) one spool for holding the clean floss and 3) the second spool for holding the used floss.

U.S. Pat. No. 5,816,271, issued Oct. 6, 1998 to Urso, discloses a self-guiding flosser which includes a frame having a pair of tines mounted on it for supporting a span of floss. At least one of pair the tines is pivotally supported for moving toward and away from the other of the pair of tines. Gear-driven capstans are provided for reciprocating the span of floss longitudinally between the tines, while a cam and cam follower act on a lever for reciprocating the tines vertically. A spring urges the tines to move laterally apart to an open position. Each of a pair of engaged sector gears is fixed to a respective tine so that lateral movement of the tines is symmetrical. The spring is adjustable so that when the moving floss span encounters tooth resistance, floss tension increases to overcome the spring force and move the tines toward a closed position. The bulbs, which contain rollers, are mounted to swivel so the floss span can move in any direction. Thus, the span can wrap around a tooth and reciprocate laterally and vertically thereabout.

Two U.S. Patents, U.S. Pat. No. 5,613,508 issued Mar. 25, 1997 and U.S. Pat. No. 5,823,207 issued Oct. 20, 1998 to Bushman, put forth a dental floss apparatus with a mechanism for collecting spent floss. An advancing mechanism allows the user to advance the floss while holding the handle and moving a knob with a finger. The fresh floss is dispensed from a spool in the handle and the used floss is collected on a separate spool. Both spools are locked during flossing, so the force from flossing does not move the spools. A brake on the dispensing spool ensures that freshly dispensed floss is at the proper tension for use. Alternatively, friction is applied along the path of the floss to supply tension to the floss as it is being dispensed. Broken floss can be easily reattached to the collecting spool. In the preferred embodiment, an empty cartridge containing the dispensing spool can be used to supply an empty collecting spool.

U.S. Pat. No. 5,606,984, issued Mar. 4, 1997 to Gao, concerns a power-driven dental flossing device has an elongate housing of three casings with an extending housing arm forked at its front, which contains dental floss reels, a dividing gear system, dental floss operating and winding switches, and a powered motor with batteries and/or a transformer. Dental floss across two tines of the forked arm is wound on the two reels, one of which supplies fresh dental floss, the other takes up used floss. The dental floss can be automatically reciprocated between the tines and teeth by pulling an operating switch backward, and also can be manipulated manually by pushing the same operating switch forward. The floss can also be automatically wound in one direction at time to provide a fresh length of the floss, or to rewind it back at any time. The floss reels are driven by the gear system which comprises pinions installed on reel shafts, and a main dividing gear with partially geared circumference to drive each one of pinions alternately, therefore the dental floss can automatically complete reciprocating motion to accomplish teeth cleaning. The main gear can also be slid to an upper or lower position on its shaft where only one pinion could be driven by the main gear, therefore the dental floss will be continually wound only in one direction at a time.

U.S. Pat. No. 3,927,687, issued Dec. 23, 1975 to Thierman, illustrates a combination shaft and spool structure, wherein the spool has a central opening for receiving a drive shaft end therein. The drive shaft has spline-like projections which engage respective recesses in the spool to provide a drive connection. The free end of the drive shaft has a slot the bottom of which terminates at an upper end thereof at two wedge-shaped projections. The spool has a diametral full width slot leading upwardly from its bottom end into which a line to be attached thereto is threaded. The difference in distance between the upper end of the slot in the spool and the upper end of the two wedge-shaped projections at the shaft slot is less than the thickness of a line to be held on the spool when the latter is installed on the shaft, thus providing a grip on a line which has previously been laid in the shaft slot and providing a starting connection for the line on the spool. A useful application of the invention is in a dental floss tooth cleaning tool wherein dental floss leads from a supply spool to a take-up spool after first passing over support arms, and it is a further object to provide means in such spool to assist in laying line in position for attachment to the spool.

U.S. Pat. No. 3,746,017, issued Jul. 17, 1973 to Casselman, is for a dental floss holder and applicator having a floss storage and dispensing reel and a floss take-up reel and an arcuate arm to hold floss in application position.

U.S. Pat. No. 3,734,107, issued May 22, 1973 to Thierman, provides a tool for holding dental floss and being capable of being manipulated for cleaning interproximal areas between the teeth. The tool has a body member supporting a supply spool of dental floss and a take-up spool. A pair of arms project from the body member and have downturned fingers across which dental floss between the supply spool and take-up spool is stretched tightly. The dental floss being supported across the fingers can be worked between the teeth by suitable manipulation of the tool. The supply spool of dental floss and the take-up spool have a rotatable connection with each other such that when new dental floss is presented to the fingers such floss is simultaneously taken up and held tight.

U.S. Pat. No. 3,667,483, issued Jun. 6, 1972 to McCabe, shows a dental floss reciprocator embodying pair of arms projecting from support frame and spaced from each other to receive teeth therebetween. Guides at outer ends of arms receive and permit relative movement of floss passing from supply reel to take-up reel. Forward and rearward angular movement imparted alternately to reels with forward movement greater than rearward movement to reciprocate and move floss progressively to take-up reel.

U.S. Pat. No. 3,340,881, issued Sep. 12, 1967 to Cowen, claims a dental floss holder having a combined take-up and supply reel which may both be moved using an extended knob.

U.S. Pat. No. 3,759,274, issued Sep. 18, 1973 to Warner, describes a dental instrument which uses a strand of dental floss for removing particles entrapped between teeth or around the bases of teeth. The strand of dental floss is mounted on an extended fork used for supporting the strand and to allow oscillating movement when used in a cleaning operation. A drive means is included for imparting the oscillating movement to the strand. There is also included a device cooperating with the spool for carrying the strand and supporting the strand for registering a new, unused strand of dental floss for operation subsequent to each cleaning cycle. The spool may be moved using an extended knob.

What is needed is a convenient device for storing and using dental floss with two separately controlled reels having control knobs and spring tensioned ratcheting mechanisms, one for unwinding unused floss to advance the unused floss into position for use between two protruding spaced flossing arms and the other to wind up the used floss for storage with both control knobs used for tensioning the floss for use so that the floss is contained within the device before and after use with no need to cut or dispose of lengths of dental floss.

### BRIEF SUMMARY OF THE INVENTION

An object of the present invention is to provide a convenient enclosed housing device for storing and using dental floss with two separately controlled reels in separate compartments, each reel having a control knob and spring tensioned ratcheting mechanism, one for unwinding unused floss to advance the unused floss into position for use between two protruding spaced flossing arms and the other to wind up the used floss for storage with both control knobs used for tensioning the floss for use so that the floss is contained within the device before and after use with no need to cut or dispose of lengths of dental floss.

Another object of the present invention is to provide a cover over the protruding flossing arms to shield the exposed floss between the ends of the arms from contamination.

One more object of the present invention is to provide a miniature brush housed in a slot in the cover for cleaning the used floss prior to winding it into the case for storage.

An additional object of the present invention is to provide two isolated housings so that the fresh floss and the used floss are effectively separated by two isolated housings (the dispensing and collecting housings) in the grip handle. When pulling out new floss there are no impurities on the floss, which means extremely hygienic use of floss and storage keeps the fresh taste on the new floss.

In brief, the dental flossing device of the present invention is a dental flossing device that advances the floss and adjusts the floss tension easily by two control knobs on the handle, one attached to an unwinding reel of clean floss and one attached to a winding reel of used floss, the two reels each having a spring loaded ratchet to allow adjusting the tension of the clean section of floss positioned with a clean section of floss between two protruding flossing arms. Using the two control knobs on the grip handle, a user can quickly pull fresh floss out and wind the used floss onto the collecting reel mounted in the grip handle, as well as appropriately adjust the tension of the floss while flossing.

The dental flossing device of the present invention can be used to floss successively for over 200 times, since total length of floss loaded in the device exceeds 7 yards. Its convenient size and comfortable grip handle allow the user to floss with one hand. The arched floss holder flossing arms allow the user to easily floss both front and back teeth while getting the maximum inter-dental access, which will effectively remove plaque above and below the gum line as well as gets rid of the food residual between teeth.

When using the flossing device of the present invention, the user does not need to replace the disposable head or cut off the used floss after each use. To allow flossing anytime anywhere, the present invention features a hygienic head cover that avoids floss contamination and allows the user to use the device either at home or away. Since the fresh floss and the used floss are effectively separated by two isolated housings (the dispensing and collecting housings) in the grip handle, there are no impurities on the floss when pulling out new floss, which means extremely hygienic use of floss. In addition, a small brush attached to the head cover is used for cleaning food residual that sticks to the used floss, which prevents food residual into the collecting housing to block the floss path.

The flossing device of the present invention contains preferably waxed floss (7-yard filament in length) with the fresh taste of mint, angled heads, hygienic head cover.

The present invention cleans the teeth, gets rid of the food residual between teeth and prevents cavities and disease.

Advantages of the present invention include:
Easy to use and to carry.
Makes flossing convenient, anywhere, anytime.
Effective in removing plaque above and below the gumline and getting rid of food residual between teeth.
Convenient size and comfortable grip handle to allow flossing with one hand.
A fresh floss for each use can be simple and quick pulled out with two control knobs on the grip handle.
The tension of the floss is appropriately adjusted by two control knobs so that the floss tension remains taut while flossing.
Angled heads allow a user to easily floss both front and back teeth and easily get the maximum interdental access.
The fresh floss and the used floss are effectively separated by two isolated housings (the dispensing and collecting housings) in the grip handle. When pulling out new floss there are no impurities on the floss, which means extremely hygienic use of floss. Also storage keeps the fresh taste on floss.
Single filament loaded in this flossing device is gentle and effective for flossing. It does not produce trauma to gum tissue.
A hygienic head cover can avoid floss contamination when the flossing device of the present invention is used either at home or away.
A small brush attached in the head cover is used for cleaning food residual that sticks to the used floss, which prevents food residual into the collecting housing to block the floss path.
Convenient teeth cleaning device for travelers or people working outside.

### BRIEF DESCRIPTION OF THE SEVERAL VIEWS OF THE DRAWINGS

These and other details of our invention will be described in connection with the accompanying drawings, which are furnished only by way of illustration and not in limitation of the invention, and in which drawings:

FIG. 1 is a top plan view of the dental floss device of the present invention with the cap installed showing the handle and control knobs;

FIG. 2 is a top plan view of the dental floss device of FIG. 1 with the cap removed showing the flossing arms on the handle and the brush removed from the cap;

FIG. 3 is a side elevational view of the dental floss device of FIG. 1 with the cap removed and the brush inserted in the cap;

FIG. 4 is a bottom plan view of the top half of the housing of FIG. 1 showing the two reels in place in the two separate chambers separated by an intermediate wall and showing the path of the elongated single strand of dental floss from the dispensing reel through one flossing arm, across the flossing space to the other flossing arm and terminating around the winding reel;

FIG. 5 is a top plan view of the bottom half of the housing of FIG. 1 which mates with the top half of the housing shown in FIG. 4;

FIG. 6 is a side elevational view of the two halves of the housing of FIG. 1 aligned for assembly.

### DETAILED DESCRIPTION OF THE INVENTION

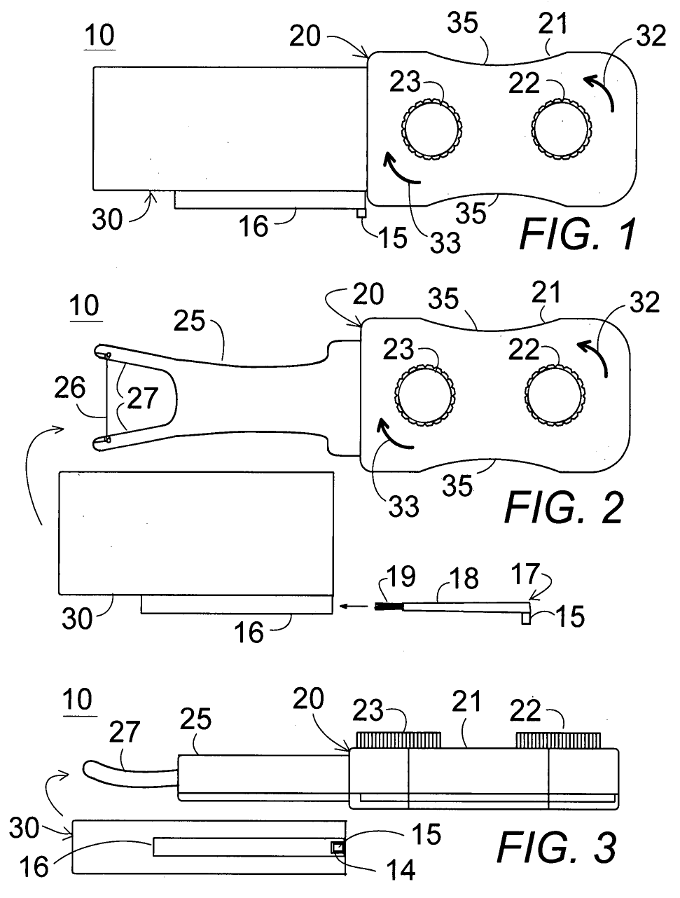

In FIGS. 1-6, a dental flossing device 10 for storing and using dental floss 26 comprises a single elongated strand of preferably round waxed dental floss 26, an angled pair of flossing arms 27 acting as a floss holder for flossing between the teeth of a user, grip handle housing 21 having an ergonomic shape with side recesses 35 for maximum gripping efficiency, a hygienic flossing arm cover 30, and a small brush 17 attached to the cover. The angled floss holder arms are each formed in an arch shape for holding a section of the dental floss 26 therebetween for use in flossing. There are two floss control knobs 22 and 23 on the grip handle housing 21, one is the new floss dispensing knob 22 and the other is the used floss collecting knob 23. They are separately connected to two isolated compartments, the dispensing compartment 2 and the collecting compartment 3 separated by a wall 11 therebetween, mounted within the grip handle housing 21. The dispensing compartment 2 is where the fresh floss supply is disposed and the collecting compartment 3 is where the used floss is stored.

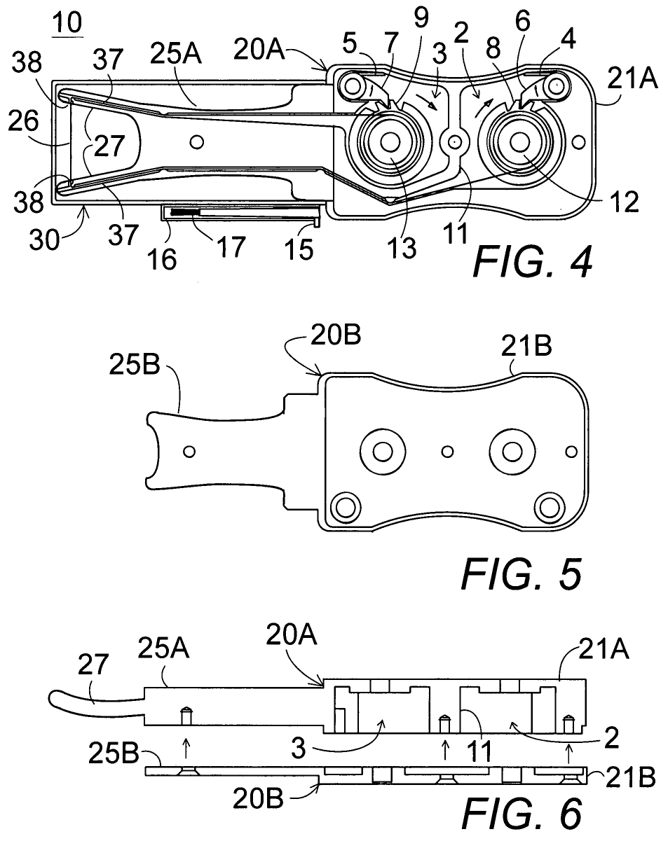

In FIGS. 4-6, the grip handle housing 21 is formed by an upper housing portion 21A and a lower housing portion 21B secured together by fasteners located at the upward pointing arrows in FIG. 6.

In FIG. 4, the new floss dispensing reel 22 has a spring loaded ratchet mechanism comprising a spring 4 loaded ratchet claw 6 which engages a notched ratchet gear 8 attached to the floss dispensing reel 12 to hold the reel in place after turning the reel a desired amount. The used floss winding reel 13 has a spring loaded ratchet mechanism positioned in a reverse orientation to the floss dispensing reel, the ratchet mechanism comprising a spring 5 loaded ratchet claw 7 which engages a notched ratchet gear 9 attached to the used floss winding reel 13 to hold the reel in place after turning the floss winding reel a desired.

In FIGS. 1-3, each of the reels has a control knob, positioned outside of the housing: a new floss dispensing reel control knob 22 attached to the new floss dispensing reel 12 and a used floss dispensing reel 23 control knob attached to the used floss winding reel 13. Indicia, such as curved arrows 32 and 33 on the outside housing adjacent to each of the control knobs indicates the direction of turning for each control knob to enable the control knobs to cooperate and wind a used portion of the dental floss onto the used floss winding reel 12 while dispensing a new portion of the dental floss from the new floss dispensing reel 12 to position a new portion of the dental floss 26 for use between the flossing arms 27, as shown in FIGS. 2 and 4.

The ratchet mechanisms lock each of the reels into a non-rotating position after each turning of the control knob so that the two control knobs also cooperate to control the tension of the dental floss 26 for use between the flossing arms 27.

In FIG. 4, the pair of spaced dental flossing arms 27 protrude from the enclosed housing 21, each of the dental flossing arms having a passageway 37 for receiving an outer portion of the dental floss 26 therein along the length of each arm and a means, such as facing openings 38 for aligning a cleaning portion of the dental floss 26 between the ends of the dental flossing arm to use the cleaning portion of the dental floss for flossing between the teeth of a user. The outer portion of the dental floss 26 extends from the new floss dispensing reel 12 out of the housing 21 up a first arm 27 (lower arm in FIG. 4) and across to the second arm 27 (upper arm in FIG. 4) and back down the second arm into the used floss winding reel 13.

The cover 30 removably snaps onto the housing 21 over the dental flossing arms 27, as shown in FIG. 4, to shield the dental flossing arms 27 and outer dental floss 26 during transport and storage of the device,

In FIGS. 1-4, the brush 17 is stored in a sleeve 16 in the cover 30 and taken out for cleaning particles from the used portion of the dental floss prior to winding the used portion of the dental floss into the housing for easier operation of the device and helping to reduce contamination of the used floss storage compartment. The brush 17 has small bristles 19 at one end attached to a handle 18 with a protruding with a protruding tab 15 which extends out of a notch 14 at the opening of the sleeve 16 for accessing the brush 17, as shown in FIGS. 3 and 4.

The spring loaded ratchet mechanism comprises a spring 4 and 5 loaded ratchet claw 6 and 7 which engages a notched ratchet gear 8 and 9 attached to the reel 12 and 13 to hold the reel in place after turning the reel a desired amount.

In use, by rotating the dispensing knob half of a circle counterclockwise, fresh floss is dispensed from a dispensing reel in the dispensing housing, and by rotating the collecting knob half of a circle clockwise; the used floss is collected on a collecting reel in the collecting housing. The tension of the floss is also appropriately adjusted by the rotation of the collecting knob. In the floss dispensing system, comprising the dispensing knob, the dispensing reel, a ratchet gear, a ratchet claw and a spring, the dispensing knob is operably connected to the dispensing reel and the ratchet gear through a connecting rod. Rotation of the dispensing knob causes both the dispensing reel and the ratchet gear to rotate in a coaxial direction, thus advancing fresh floss from the dispensing reel. When the dispensing knob is released, the ratchet claw and the spring, which function together as the stopper, cooperate with the serrate ratchet gear to provide a ratchet mechanism that stops rotating the dispensing reel and helps to adjust the floss tension. In the other set of floss collecting system, comprising the collecting knob, the collecting reel, another ratchet gear, another ratchet claw and another spring, the collecting knob is operably connected to the collecting reel and the ratchet gear through a connecting rod. Rotation of the collecting knob half of a circle clockwise causes both the collecting reel and the ratchet gear to rotate in a coaxial direction, thus winding the used floss onto the collecting reel. The ratchet claw and the spring in this system function together also as the stopper to stop rotating the collecting reel and ensure that fresh dispensed floss being at the proper tension for use. After engaging and rotating both the dispensing knob and the collecting knob, the fresh floss strand from the dispensing reel will be threaded through the dispensing housing into the tip of the angled floss holder where it passes two openings and returns into the collecting reel in the collecting housing.

Operationally to use the present invention, the following steps are followed:

### Step 1 Remove the head cover

Step 2 Before use, test the tension of the floss using a finger. If the tension of the floss is too tough, rotate the bottom knob on the grip handle a little bit to the direction indicated by arrow to reduce the tension. If the tension of the floss is too slack, rotate the upper knob a little bit to the direction indicated by arrow to make the floss taut

### Step 3 After flossing, clean the floss with a small brush that is attached in the head cover

### Step 4 Rotate the bottom knob half of a circle counterclockwise to the direction indicated by arrow, which will pull out the fresh floss from the dispensing housing

### Step 5 Rotate the upper knob half of a circle clockwise to the direction indicated by arrow, which will wind the used floss into the collecting housing

### Step 6 Close the head cover

### Step 7 Repeat procedure as mentioned above when it is used next time.

It is understood that the preceding description is given merely by way of illustration and not in limitation of the invention and that various modifications may be made thereto without departing from the spirit of the invention as claimed.

What is claimed is:

1. A dental flossing device for storing and using dental floss comprises:
an enclosed housing for housing a single long strand of dental floss, the enclosed dousing comprising a clean floss storage compartment for storing a clean portion of the dental floss and a used floss storage compartment for storing a used portion of the dental floss; a new floss dispensing reel having a spring loaded ratchet mechanism in the clean floss storage compartment and a used floss winding reel having a spring loaded ratchet mechanism in the used floss storage compartment; each of the reels having a control knob positioned outside of the housing, a new floss dispensing reel control knob attached to the new floss dispensing reel and a used floss dispensing reel control knob attached to the used floss winding reel; indicia on the outside casing adjacent to each of the control knobs indicating the direction of turning for each control knob to enable the control knobs to cooperate and wind a used portion of the dental floss onto the used floss winding reel while dispensing a new portion of the dental floss from the new floss dispensing reel to position a new portion of the dental floss for use, the ratchet mechanisms locking each of the reels into a non-rotating position after each turning of the control knob so that the two control knobs also cooperate to control the tension of the dental floss;
a pair of spaced dental flossing arms protruding from the enclosed housing, each of the dental flossing arms having a passageway for receiving an outer portion of the dental floss therein along the length of each arm and a means for aligning a cleaning portion of the dental floss between the ends of the dental flossing arm to use the cleaning portion of the dental floss for flossing between the teeth of a user, the outer portion of the dental floss extending from the new floss dispensing reel out of the housing up a first arm and across to the second arm and back down the second arm into the used floss winding reel;
a cover to removably snap onto the housing over the dental flossing arms to shield the dental flossing arms and outer dental floss during transport and storage of the device,
a brush stored in the cover for cleaning particles from the used portion of the dental floss prior to winding the used portion of the dental floss into the housing for easier operation of the device and helping to reduce contamination of the used floss storage compartment.

2. The device of claim 1 wherein the spring loaded ratchet mechanism comprises a spring loaded ratchet claw which engages a notched ratchet gear attached to the reel to hold the reel in place after turning the reel a desired amount.
